(19) United States
(12) Patent Application Publication
(10) Pub. No.: US 2025/0314020 A1
(43) Pub. Date: Oct. 9, 2025

(54) SYSTEMS, MIXTURES AND METHODS OF PRODUCING PAVING PRODUCTS USING SAME

(71) Applicant: Gary Wilson, Calgary (CA)

(72) Inventors: Gary Wilson, Calgary (CA); David Babich, Calgary (CA)

(73) Assignee: Gary Wilson, Calgary (CA)

(21) Appl. No.: 19/243,596

(22) Filed: Jun. 19, 2025

Related U.S. Application Data
(63) Continuation-in-part of application No. 18/828,049, filed on Sep. 9, 2024.
(63) Continuation-in-part of application No. 18/120,327, filed on Mar. 10, 2023.
Application No. 18/828,049 is a continuation-in-part of application No. 18/120,327, filed on Mar. 10, 2023.

(51) Int. Cl. E01C 19/10; E01C 19/08

(52) U.S. Cl. CPC E01C 19/10; E01C 19/08

(57) ABSTRACT

A material processing system or method for heating and/or metered dispensing of a mixture material formed from desired proportions of recycled asphalt shingle and recycled asphalt pavement is disclosed. The methods of molding the mixture into paving or construction blocks, which exhibit properties of high compressive strength and low water absorption, are described. The paving blocks may be used to construct roads, parking lots, driveways, etc. The system includes a vertical heat exchanger and a material feeder. The heat exchanger utilizes flue gas to heat the material traveling through conduits. The material feeder includes a rotating drum to receive the heated material from the heat exchanger and meter out an amount of the heated material using pockets defined between paddles of the metering drum. The metered amount of the heated material can then be provided to a transfer device for molding into the blocks or directly to a molding system.

### CROSS-REFERENCE TO RELATED APPLICATION

This application is a continuation-in-part under 35 U.S.C. § 120 based upon co-pending U.S. patent application Ser. No. 18/828,049 filed on Sep. 9, 2024, and U.S. patent application Ser. No. 18/120,327 filed on Mar. 10, 2023, which are incorporated herein by reference in their entirety.

### TECHNICAL FIELD

In some aspects, the present technology relates to a systems, mixtures and methods for use in connection with producing paving products from recycled material. In some other aspects, the present technology relates to systems or methods associated with preparing paving blocks comprising a mixture of recycled asphalt shingles (RAS) and recycled asphalt pavement (RAP) particles.

### BACKGROUND

Without limiting the scope of the present technology, its background is described in connection with materials and methods for producing paving blocks. More particularly, the present technology describes mixtures and methods for using thereof to mold various paving blocks.

Up to 11 million tons of post-consumer asphalt shingle waste is generated annually in North America. A portion of this is processed into RAS (recycled asphalt shingle, which is a powder-like substance resulting from decontamination and grinding of shingles) and diverted successfully into use as a dust suppressant on gravel roads and parking lots, and as an additive in hot mix asphalt. But these uses have significant limitations (low value in the case of dust suppressant, and road specifications issues in the case of hot mix asphalt), and much of the post-consumer asphalt shingle waste ends up being land-filled. Further, up to 4 million tons of post-consumer asphalt flat roofing is generated annually in North America, and most or all of this is currently landfilled. An alternative market as a material for use in forming paving blocks could raise the value of RAS and lead toward greater diversion of post-consumer asphalt shingle waste from landfills; similarly, this same market could lead toward the diversion of post-consumer asphalt flat roofing waste from landfills.

A close analog of RAS is RAP (recycled asphalt pavement, which is a gravel-like substance resulting from the milling of road surfaces or the crushing of broken asphalt pavement). Like RAS, RAP is used as an additive in hot mix asphalt, and in fact, is used much more extensively than RAS there. The proportion of RAP that is not used in hot mix asphalt has a lower value use as a gravel substitute, and so waste asphalt pavement is seldom land-filled. However, an alternative market as a material for use in forming paving blocks could raise the value of RAP and lead to a greater proportion of it being used in a higher value use than as a gravel substitute.

Asphalt cement (a form of bitumen) is present in both RAS and RAP. It is the binder still present in both materials. RAS typically has a range of 18-24% asphalt cement, whereas RAP has a much lower asphalt cement content, in the range of 5-6%. Asphalt cement is normally the most expensive material in the manufacture of roofing materials or hot mix asphalt, even at the low percentage of 5-6%, and so a recycling use that is able to harness the binder quality of post-consumer asphalt cement may be optimal with relation to material value.

The prior art fails to disclose the use of RAS and RAP, along with heat and pressure, as a basis for producing paving blocks. The need exists, therefore, for an improved method and improved components to be used for producing more durable paving blocks.

### SUMMARY

Accordingly, it is an object of the present technology to overcome these and other drawbacks of the prior art by providing a novel mixture for producing paving blocks.

It is another object of the present technology to provide a novel method of forming paving blocks using the mixture of the present technology.

It is a further object of the present technology to provide methods of increasing the use of recycled materials in preparing paving blocks.

The present technology provides a mixture for producing paving products comprising recycled asphalt shingles (RAS) and recycled asphalt pavement (RAP) particles. The use of these components to form a resulting composite material provides a material that has considerable strength and durability, and absorbs a minimal amount of water, therefore making it nearly impervious to damage caused by the freeze/thaw cycle.

Further, the present technology provides a molded paving block using a mixture for producing paving products comprising RAP and RAS particles that are to be used to construct roads, parking lots, driveways, floors, and the like. The molded paving blocks of the present technology are to be used substantially in the same manner as presently available interlocking blocks.

The materials used are preferably recycled materials such as RAS and RAP. However, aggregate, whether virgin aggregate or recycled rock-like materials such as crushed glass, crushed concrete, crushed rubble, crushed seashells, sand tailings, et cetera, may be substituted or partially substituted for the RAP. There are many advantages to using recycled materials, such as the reduction of waste and lower cost of raw materials.

In some embodiments, proportional amounts of materials in the composite material include RAP in a proportion of about 35% by mass, RAS in a proportion of about 30% by mass, rock-like material that is not RAP in a proportion of about 25% by mass, and hard surfacing material in a proportion of about 10% by mass.

In some embodiments, proportional amounts of materials in the composite material include RAP in a proportion of about 60% by mass, RAS in a proportion of about 25% by mass, rock-like material that is not RAP in a proportion of about 10% by mass, and hard surfacing material in a proportion of about 5% by mass.

The RAP should generally be the main or prevalent constituent of the composite material that forms the composite block of the present technology. However, the RAS, although generally a secondary constituent of the composite material, is of equal importance to the RAP because it contains a much higher percentage of the binder, asphalt cement, than does the RAP. The RAP (and other aggregates) provides the compressive strength and abrasion resistance of the composite material, whereas the RAS provides most of its cleavage strength and resistance to water absorption. The two together make a far superior paver than could be made with either alone.

Further, the present technology provides a process for manufacturing molded paving blocks, comprising the steps of heating and molding RAS and RAP into a molded paving block.

According to one aspect, the present technology can relate to a material processing system including a heat exchanger configured to receive a material. The heat exchanger can include a heat exchanger body and one or more material conduits. The heat exchanger body can define therein a heat exchanger cavity and can include an upper end and a lower end. The material conduits can extend through the heat exchanger cavity from the upper end to the lower end, and can be configured to allow the material to flow therethrough by gravity without being in communication with the heat exchanger cavity. The heat exchanger body can be configured to receive a heated flue gas from a flue gas source and allow the heated flue gas to flow through the heat exchanger cavity to heat the material flowing in the material conduits to create a heated material.

According to another aspect, the present technology can relate to a material processing system including a material feeder configured to receive a heated material. The material feeder can comprise a cylindrical body and a metering drum. The cylindrical body can define a body cavity therein, a receiving opening defined through the cylindrical body, and a discharge opening defined through the cylindrical body. The metering drum can be rotatable in the cylindrical body, and can comprise a cylindrical drum body, and multiple paddles extending outwardly from the drum body. A pocket can be defined between each of the paddles and is configured to receive an amount of the heated material to create a metered amount of the heated material.

According to yet another aspect, the present technology can relate to a material processing system including a heat exchanger configured to receive a material, and a material feeder. The heat exchanger can comprise a heat exchanger body, and one or more material conduits. The heat exchanger body can define a heat exchanger cavity and having an upper end and a lower end. The material conduits can extend through the heat exchanger cavity from the upper end to the lower end. The material conduits can be configured to allow the material to flow therethrough by gravity without being in communication with the heat exchanger cavity. The heat exchanger body can be configured to receive a heated flue gas from a flue gas source and allow the heated flue gas to flow through the heat exchanger cavity and heat the material flowing in the material conduits to create a heated material. The material feeder can be configured to receive the heated material from the material conduits of the heat exchanger. The material feeder can include a meter dispensing section including a cylindrical body and a metering drum. The cylindrical body can define a body cavity therein, a receiving opening defined through the cylindrical body, and a discharge opening defined through the cylindrical body. The metering drum can be rotatable in the cylindrical body, and can comprise a cylindrical drum body, and multiple paddles extending outwardly from the drum body. A pocket can be defined between each of the paddles and is configured to receive an amount of the heated material to create a metered amount of the heated material.

According to still another aspect, the present technology can relate to a method of using the material processing system for making one or more construction blocks using a mixture material. The method can include the steps of mixing recycled asphalt shingle particles and recycled asphalt pavement particles to produce a homogenous mixture material thereof. Providing the homogenous mixture material to the upper end of the heat exchanger for flowing by gravity through the material conduits toward the lower end. Heating the homogenous mixture material to a temperature from 200 degrees F. (93.33° C.) to 425 degrees F. (218.33° C.) to form the heated material by flowing the heated flue gas through the heat exchanger cavity in a counter direction to that of the flow of the homogenous mixture material through the material conduits. Receiving the heated material in the receiving opening of the material feeder for collection in the pocket of the metering drum to create the metered amount of the heated material. Rotating the metering drum to transfer the metered amount of the heated material in the pocket to the discharge opening. Distributing the metered amount of the heated material to a molding system to form the construction blocks.

Some embodiments of the present technology can include a heat exchanger alone or in combination with the material feeder, and the heat exchanger can be configured to heat a material to create the heated material and provide the heated material to the material feeder. The heat exchanger can include a heat exchanger body and one or more material conduits. The heat exchanger body can define a heat exchanger cavity and having an upper end and a lower end. The material conduits can extend through the heat exchanger cavity from the upper end to the lower end. The material conduits can be configured to allow the material to flow therethrough by gravity without being in communication with the heat exchanger cavity. The heat exchanger body can be configured to receive a heated flue gas from a flue gas source and allow the heated flue gas to flow through the heat exchanger cavity to heat the material flowing in the material conduits to create the heated material.

In some embodiments, the heat exchanger can be vertically oriented and configured to allow the material to travel downwardly through the material conduits by gravity toward the lower end, and the heated flue gas to travel upwardly through the heat exchanger cavity around the material conduits toward the upper end.

In some embodiments, the upper end of the heat exchanger can be configured to receive the material from a hopper and allow the material to be received in the material conduits.

In some embodiments, the heat exchanger can further comprise one or more support dividers positioned in the heat exchanger cavity.

In some embodiments, the support dividers can include one or more conduit bores defined therethrough and one or more gas ports defined therethrough. The conduit bores can be configured to receive therethrough one or more of the material conduits, and the gas ports can be configured to allow the heated flue gas to flow therethrough.

Some embodiments of the present technology can include a material feeder alone or in combination with the heat exchanger, and the material feeder can be configured to receive the heated material

In some embodiments, the material feeder can be configured to receive the heated material from the material conduits of the heat exchanger.

In some embodiments, the material feeder can include a meter dispensing section that can include a cylindrical body and a metering drum. The cylindrical body can define a body cavity therein, a receiving opening defined through the cylindrical body, and a discharge opening defined through the cylindrical body. The metering drum can be rotatable in the cylindrical body, and can comprise a cylindrical drum body, and multiple paddles extending outwardly from the drum body. A pocket can be defined between the paddles and can be configured to receive an amount of the heated material to create a metered amount of the heated material.

In some embodiments, the cylindrical drum body can be operatively engaged with a shaft driven by a motor for rotating the shaft and thereby the cylindrical drum body.

In some embodiments, the receiving opening can be configured to receive the heated material from the material conduits, and the discharge opening can be configured to receive the metered amount of the heated material from the pocket and discharge the metered amount of the heated material therethrough to a material transfer device or a molding system.

In some embodiments, the material feeder can further comprise a receiving section and a discharge section. The receiving section can include side walls defining a material receiving cavity, an upper end configured to cooperate with the lower end of the heat exchanger body, and a lower end configured to communicate with the receiving opening of the cylindrical body. The discharge section can include side walls defining a discharge cavity in communication with the discharge opening of the cylindrical body.

In some embodiments, the receiving section can further include one or more feeder conduits extending into the material receiving cavity towards the receiving opening of the cylindrical body, and wherein each of the feeder conduits can be configured to align with one of the one or more material conduits to transfer the heated material therefrom to the receiving opening of the cylindrical body.

According to still yet another aspect, the present technology relates to a method of manufacturing one or more paving blocks using a mixture. The method can include the following steps:
(a) mixing recycled asphalt shingle particles and recycled asphalt pavement particles to produce a homogenous mixture thereof;
(b) heating the homogenous mixture of step (a) to a temperature from 200 degrees F. (93.33° C.) to 425 degrees F. (218.33° C.);
(c) distributing the heated mixture into a molding system; and
(d) applying pressure using the molding system to form the paving blocks.

According to another aspect, the present technology relates to a method of manufacturing one or more paving blocks using a mixture. The method can include the following steps:
(a) mixing recycled asphalt shingle particles and recycled asphalt pavement particles to produce a homogenous mixture thereof;
(b) transferring the homogenous mixture of step (a) to a molding system using a heated auger and heating the homogenous mixture to a temperature from 200 degrees F. (93.33° C.) to 425 degrees F. (218.33° C.) while traveling through the heated auger; and
(c) applying pressure using the molding system to form the paving blocks.

In some embodiments, the pressure can be at or above 800 pounds per square inch (55.16 Bars), and in some embodiments at or above 2,000 pounds per square inch (137.90 Bars).

Some embodiments of the present technology can include a step of mixing rock-like material that is not recycled asphalt pavement in with the recycled asphalt shingle particles and recycled asphalt pavement particles to produce a homogenous mixture in step (a).

Some embodiments of the present technology can include a step of placing hard surfacing material into the molding system prior to the step of distributing the heated mixture into a molding system.

In some embodiments, the heating of the homogenous mixture can be conducted in a transfer device that performs the step of distributing the heated mixture or transferring the homogenous mixture to the molding system.

In some embodiments, the transfer device can be an auger system configured to heat the mixture traveling therethrough.

In some embodiments, the auger system can include:
an inner body defining an inner chamber configured to receive the homogenous mixture and transport the homogenous mixture to the molding system; and
an outer body outwardly concentric with the inner body, the outer body defining an outer sealed chamber configured to heat the homogenous mixture traveling through the inner chamber.

In some embodiments, the auger system can include an auger rotatably received in the inner chamber and configured to advance the homogenous mixture along a longitudinal length of the auger system.

In some embodiments, the auger system can include one or more vents extending through the outer chamber to fluidly communicate the inner chamber with an outside of the outer body.

In some embodiments, the outer chamber can be configured to receive a heated fluid to heat the homogenous mixture traveling through the inner chamber.

In some embodiments, the outer chamber can include a helical baffle located between the outer body and the inner body. The helical baffle can be configured to circulate the heated fluid as it travels through the outer chamber.

In some embodiments, the outer chamber can be separated into a first outer chamber and a second outer chamber. The first outer chamber can receive a first heated fluid at a first temperature, and the second outer chamber can receive a second heated fluid at a second temperature greater than the first temperature.

Some embodiments of the present technology can include a step of distributing the heated mixture into compartments of the molding system.

In some embodiments, the molding system can include an actuator configured to move the paving blocks out from the molding system.

In some embodiments, the molding system can be an extruder configured to produce a continuous paving block.

Some embodiments of the present technology can include a step of cutting the continuous paving block into the paving blocks.

According to another aspect, the present technology can include a mixture for producing paving products comprising recycled asphalt pavement particles in the amount of 20 to 90 percent of the mixture by weight, and recycled asphalt shingle particles.

According to still another aspect, the present technology can include a paving block produced using a mixture comprising recycled asphalt pavement particles in the amount of 20 to 80 percent of the mixture by weight, and recycled asphalt shingle particles.

According to yet another aspect, the present technology can include a method of manufacturing a paving block using a mixture comprising recycled asphalt pavement particles in the amount of 20 to 90 percent of the mixture by weight, and recycled asphalt shingle particles. The method can include the steps of:
(a) mixing recycled asphalt shingle particles and recycled asphalt pavement particles to produce a homogenous mixture thereof;
(b) positioning the mixture of step (a) into a primary molding system configured to produce a self-supporting preform;
(c) applying a first pressure using the primary molding system to mold the mixture contained therein into a self-supporting preform;
(d) heating up the self-supporting preform to a temperature from 200 degrees F. (93.33° C.) to 425 degrees F. (218.33° C.);
(e) transferring the self-supporting preform to a secondary molding system; and
(f) applying a second pressure using the secondary molding system to mold the self-supporting preform into a paving block.

In some embodiments, the amount of recycled asphalt shingle particles can be from 5 to 80 percent of the mixture by weight, or can be from 10 to 40 percent of the mixture by weight.

Some embodiments of the present technology can include a rock-like material that is not recycled asphalt pavement.

In some embodiments, the amount of rock-like material that is not recycled asphalt pavement can be from 5 to 50 percent of the mixture by weight.

In some embodiments, the rock-like material that is not recycled asphalt pavement can be selected from a group consisting of virgin rock such as sand and gravel or recycled rock-like materials such as crushed glass, crushed concrete, crushed rubble, crushed seashells et cetera.

Some embodiments of the present technology can include a hard surfacing material.

In some embodiments, an amount of hard surfacing can be from 2 to 15 percent of the mixture by weight.

In some embodiments, the hard surfacing material can be selected from a group consisting of rocks, pieces of metal, synthetic rocks, or a mix thereof.

In some embodiments, the mixture can contain at least 20 percent by weight of the recycled asphalt shingle particles, at least 25 percent by weight of the recycled asphalt pavement particles, at least 15 percent by weight of the rock-like material that is not recycled asphalt pavement, and at least 2 percent by weight of the hard surfacing material.

In some embodiments, no recycled asphalt pavement particle or recycled asphalt shingle particle or rock-like material particle that is not recycled asphalt pavement is larger than 1 inch, and no hard surfacing material particle is larger than ⅜ of an inch.

In some embodiments, the paver can be characterized by being able to withstand a compressive force of at least 800 pounds per square inch (55.16 Bars) and allowing no more than 4% water absorption.

In some embodiments, the first pressure can be at or above 800 pounds per square inch (55.16 Bars), and in some embodiments at or above 2,000 pounds per square inch (137.90 Bars).

In some embodiments, the second pressure can be at or above 800 pounds per square inch (55.16 Bars), and in some embodiments at or above 2,000 pounds per square inch (137.90 Bars).

In some embodiments, the method step (d) can be accomplished using a continuous feed oven with a traveling belt.

Some embodiments of the present technology can include a step of mixing rock-like material that is not recycled asphalt pavement in with the recycled asphalt shingle particles and recycled asphalt pavement particles to produce a homogenous mixture in step (a).

Some embodiments of the present technology can include a step of positioning a hard surfacing material into the primary molding system prior to performing step (b).

Some embodiments of the present technology can include a step of positioning a hard surfacing material into the secondary molding system prior to performing step (e).

According to still another aspect, the present technology can include a method of manufacturing paving blocks using a mixture comprising recycled asphalt pavement particles in the amount of 20 to 80 percent of the mixture by weight, and recycled asphalt shingle particles. The method can include the steps of:
(a) mixing recycled asphalt shingle particles and recycled asphalt pavement particles to produce a homogenous mixture thereof;
(b) heating the homogenous mixture of step (a) while continuing to mix the components thereof to a temperature from 200 degrees F. (93.33° C.) to 425 degrees F. (218.33° C.);
(c) distributing the heated mixture into compartments of a molding system; and
(d) applying pressure using the molding system to form the paving blocks.

In some embodiments, the pressure in step (d) can be at or above 800 pounds per square inch (55.16 Bars), and in some embodiments at or above 2,000 pounds per square inch (137.90 Bars).

Some embodiments of the present technology can include a step of mixing rock-like material that is not recycled asphalt pavement in with the recycled asphalt shingle particles and recycled asphalt pavement particles to produce a homogenous mixture in step (a).

Some embodiments of the present technology can include a step of placing hard surfacing material into the compartments of the molding system prior to step (c).

According to still yet another aspect, the present technology can include a method of manufacturing paving blocks using a mixture comprising recycled asphalt pavement particles in the amount of 20 to 80 percent of the mixture by weight, and recycled asphalt shingle particles. The method can include the steps of:
(a) filling compartments of a molding system with recycled asphalt shingle particles and recycled asphalt pavement particles in a manner that causes a homogenous mixture thereof to be formed in each compartment thereof;
(b) heating the molding system to a temperature from 200 degrees F. (93.33° C.) to 425degrees F. (218.33° C.); and
(c) applying pressure using the molding system to form the paving blocks.

In some embodiments, the pressure in step (c) can be at or above 800 pounds per square inch (55.16 Bars), and in some embodiments at or above 2,000 pounds per square inch (137.90 Bars).

Some embodiments of the present technology can include a step of filling compartments of a molding system with recycled asphalt shingle particles and recycled asphalt pavement particles and rock-like material that is not recycled asphalt pavement in a manner that causes a homogenous mixture thereof to be formed in each compartment thereof in step (a).

Some embodiments of the present technology can include a step of placing hard surfacing material into the compartments of the molding system prior to step (a).

According to yet still another aspect, the present technology can include a method of manufacturing paving blocks using a mixture comprising recycled asphalt pavement particles in the amount of 20 to 80 percent of the mixture by weight, and recycled asphalt shingle particles. The method can include the steps of:
(a) filling compartments of a primary molding system with recycled asphalt shingle particles and recycled asphalt pavement particles of claim 1 in a manner that causes a homogenous mixture thereof to be formed in each compartment thereof;
(b) compressing the primary molding system to produce self-supporting preforms;
(c) heating up the self-supporting preforms to a temperature from 200 degrees F. (93.33°° C.) to 425 degrees F. (218.33° C.);
(d) transferring the self-supporting preforms to a secondary molding system; and
(e) compressing the secondary molding system to form the self-supporting preforms into paving blocks.

In some embodiments, the pressure in step (b) can be at or above 800 pounds per square inch (5.16 Bars), and in some embodiments at or above 2,000 pounds per square inch (137.90 Bars).

In some embodiments, the pressure in step (e) can be at or above 800 pounds per square inch (55.16 Bars), and in some embodiments at or above 2,000 pounds per square inch (137.90 Bars).

Some embodiments of the present technology can include a step of filling compartments of a primary molding system with recycled asphalt shingle particles and recycled asphalt pavement particles and rock-like material that is not recycled asphalt pavement in a manner that causes a homogenous mixture thereof to be formed in each compartment thereof in step (a).

Some embodiments of the present technology can include a step of placing hard surfacing material into the compartments of the primary molding system prior to step (a).

Some embodiments of the present technology can include a step of placing hard surfacing material into the compartments of the secondary molding system prior to step (d).

In some embodiments, step (c) can be accomplished using a continuous feed oven with a traveling belt.

In one embodiment of the present technology, the RAS and RAP are placed into a pugmill to be blended into a composite material; this composite material is molded in a press into a preform, and the preform is then heated in a conveyor oven to about 400 degrees Fahrenheit (F) (204.44° C.) and afterward, the heated preform is molded into a molded paving block in a second press.

In another embodiment of the present technology, the RAS and RAP are placed into a pugmill to be blended into a composite material, and the composite material is conveyed in a heated auger that heats the composite material to about 400 degrees F. (204.44° C.) and deposits the heated composite material into a press where it is molded into a molded paving block.

In another embodiment of the present technology, the RAS and RAP are molded in a press heated to about 400 degrees F. (204.44° C.) into a molded paving block.

In yet another embodiment of the present technology, the RAS and RAP are molded in a press into a preform, the preform is heated in a conveyor oven to about 400 degrees F. (204.44° C.), and then the heated preform is molded into a molded paving block in a second press.

There has thus been outlined, rather broadly, features of the present technology in order that the detailed description thereof that follows may be better understood and in order that the present contribution to the art may be better appreciated.

Numerous objects, features and advantages of the present technology will be readily apparent to those of ordinary skill in the art upon a reading of the following detailed description of the present technology, but nonetheless illustrative, embodiments of the present technology when taken in conjunction with the accompanying drawings.

As such, those skilled in the art will appreciate that the conception, upon which this disclosure is based, may readily be utilized as a basis for the designing of other structures, methods and systems for carrying out the several purposes of the present technology. It is, therefore, that the claims be regarded as including such equivalent constructions insofar as they do not depart from the spirit and scope of the present technology.

It is therefore an object of the present technology to provide new and novel mixtures and methods for producing paying products that has all of the advantages of the prior art mixtures and methods and none of the disadvantages.

It is another object of the present technology to provide a new and novel mixtures and methods for producing paying products that may be easily and efficiently manufactured and marketed.

An even further object of the present technology is to provide a new and novel mixtures and methods for producing paying products that has a low cost of manufacture with regard to both materials and labor, and which accordingly is then susceptible of low prices of sale to the consuming public, thereby making such mixtures and methods for producing paying products economically available to the buying public.

Still another object of the present technology is to provide a new mixtures and methods for producing paying products that provides in the apparatuses and methods of the prior art some of the advantages thereof, while simultaneously overcoming some of the disadvantages normally associated therewith.

These together with other objects of the present technology, along with the various features of novelty that characterize the present technology, are pointed out with particularity in the claims annexed to and forming a part of this disclosure. For a better understanding of the present technology, its operating advantages and the specific objects attained by its uses, reference should be made to the accompanying drawings and descriptive matter in which there are illustrated embodiments of the present technology. Whilst multiple objects of the present technology have been identified herein, it will be understood that the claimed present technology is not limited to meeting most or all of the objects identified and that some embodiments of the present technology may meet only one such object or none at all.

### DETAILED DESCRIPTION OF THE DRAWINGS

Subject matter is particularly pointed out and distinctly claimed in the concluding portion of the specification. The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through the use of the accompanying drawings, in which:

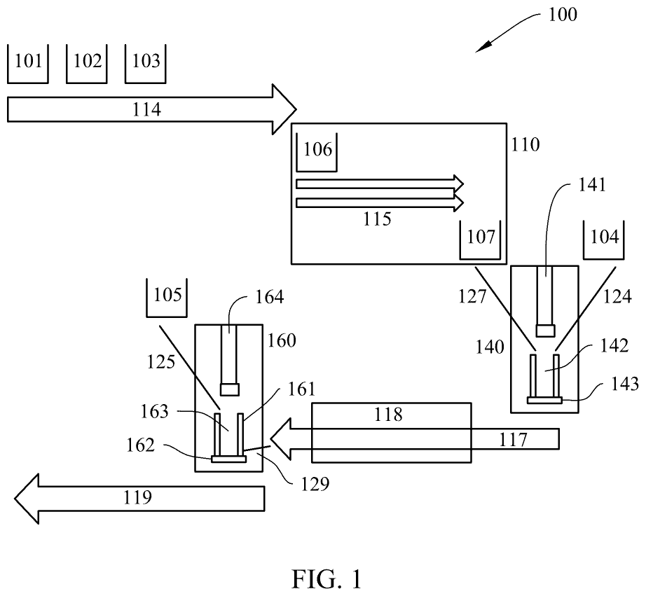

FIG. 1 is a schematic diagram of a first process used to produce the molded paving block of the present technology.

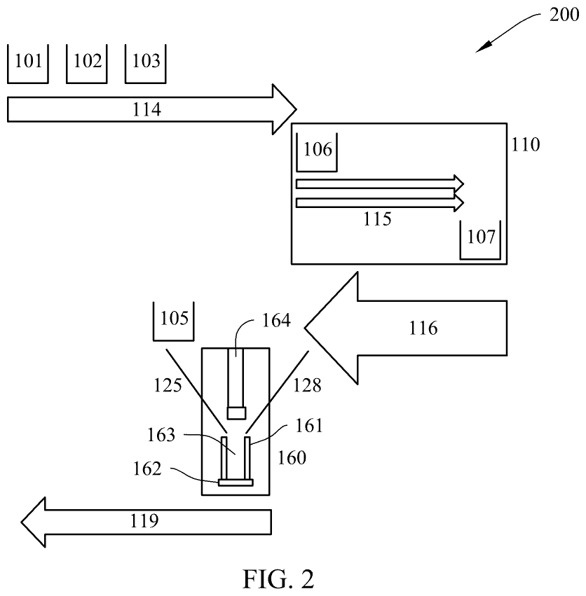

FIG. 2 is a schematic diagram of a second process used to produce the molded paving block of the present technology.

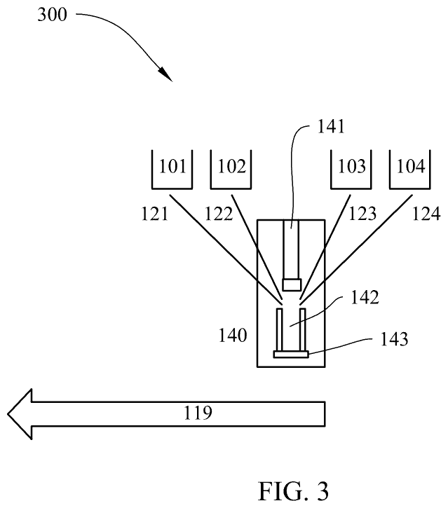

FIG. 3 is a schematic diagram of a third process used to produce the molded paving block of the present technology.

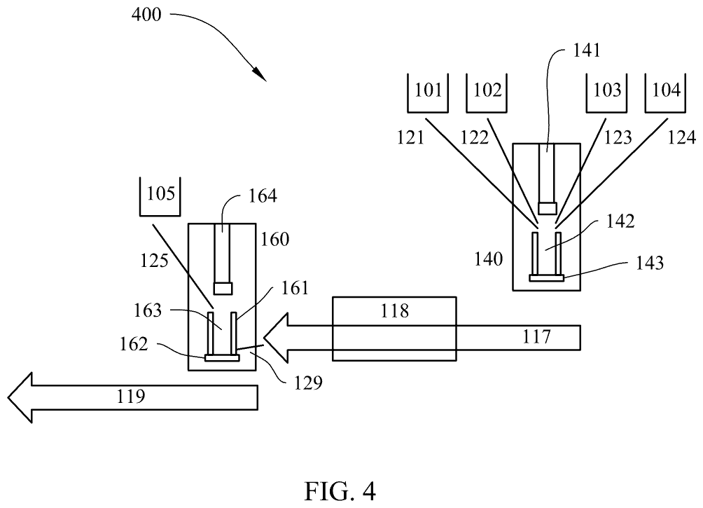

FIG. 4 is a schematic diagram of a fourth process used to produce the molded paving block of the present technology.

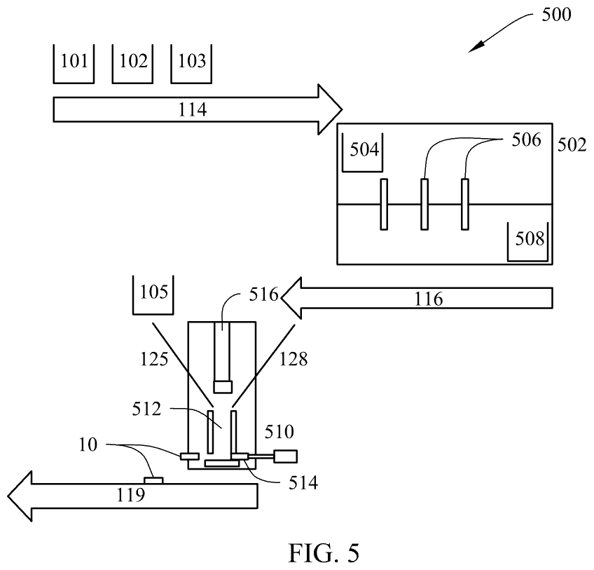

FIG. 5 is a schematic diagram of a fifth process used to produce the molded paving block of the present technology.

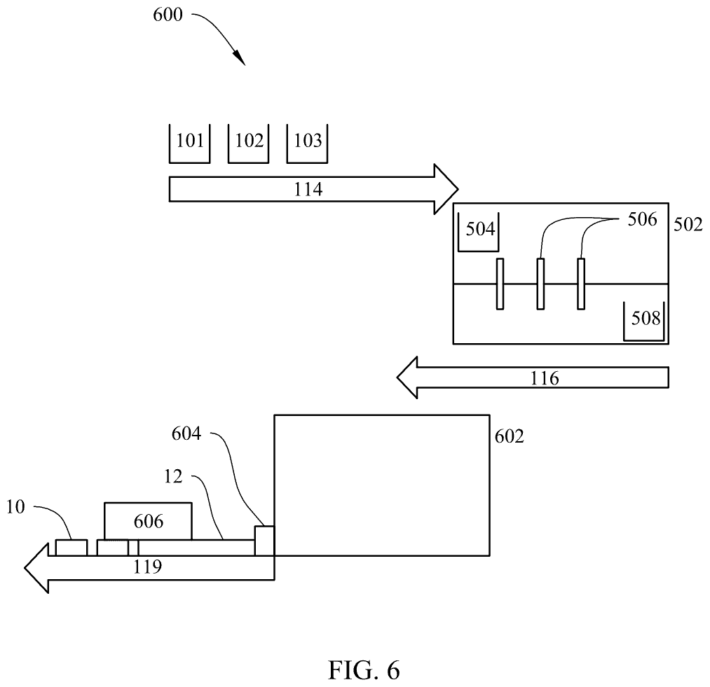

FIG. 6 is a schematic diagram of a sixth process used to produce the molded paving block of the present technology.

FIG. 7 is a perspective view of the auger system of the present technology.

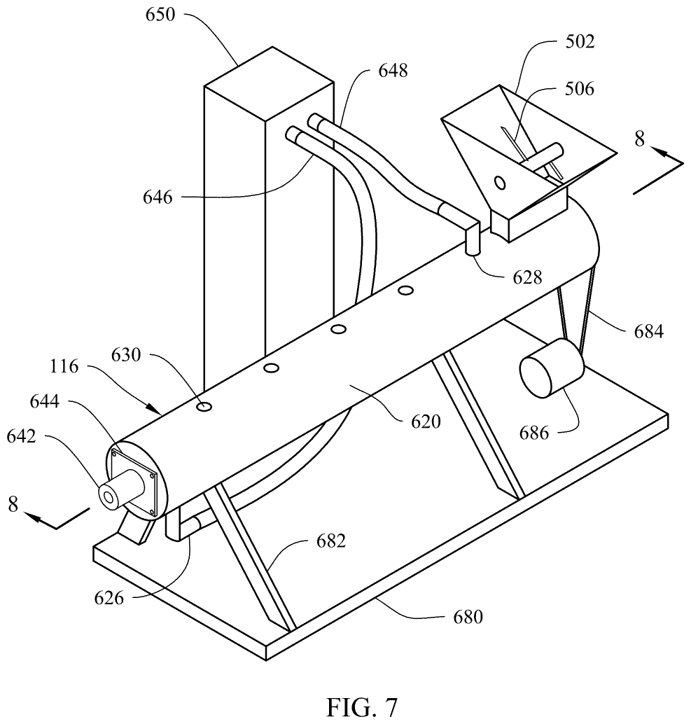

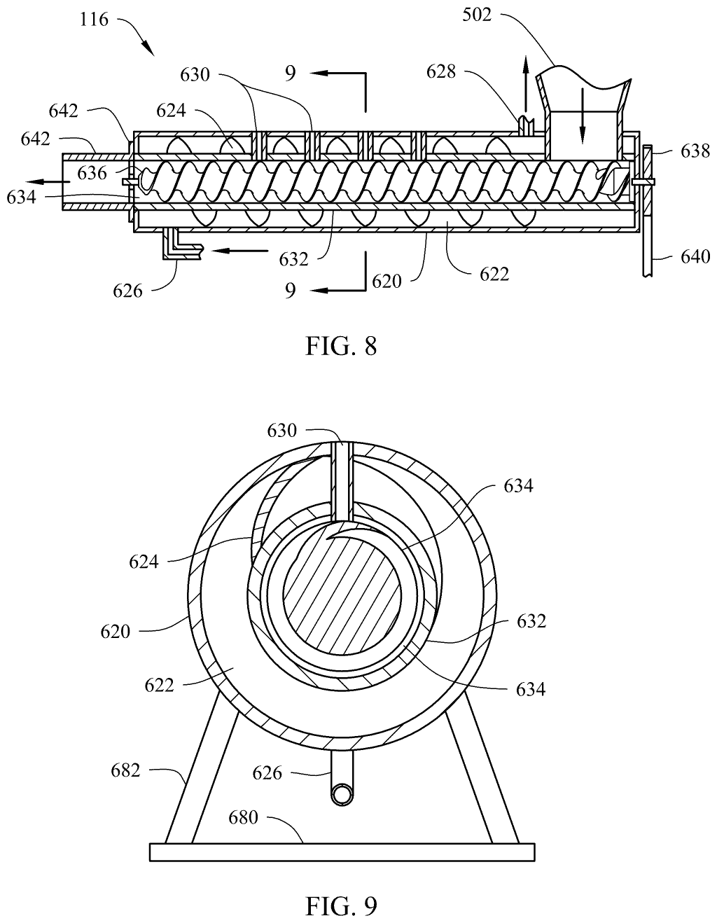

FIG. 8 is a cross-sectional view of the auger system taken along line 8 in FIG. 7.

FIG. 9 is a cross-sectional view of the auger system taken along line 9 in FIG. 8.

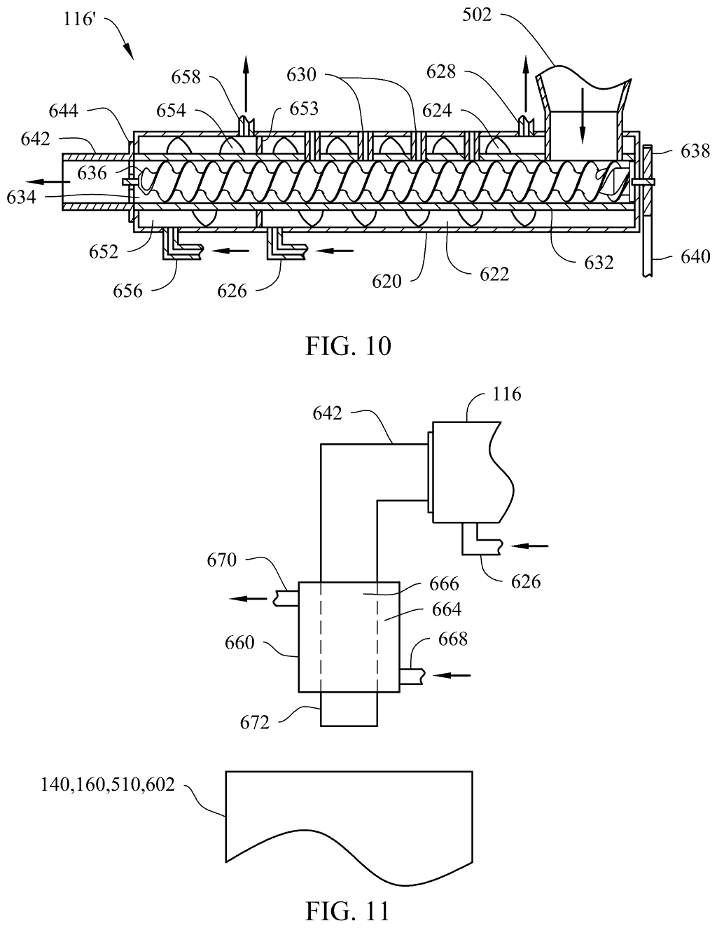

FIG. 10 is a cross-sectional view of the alternate embodiment auger system including a first stage outer chamber and a second stage outer chamber.

FIG. 11 is a schematic diagram showing a second heating section downstream of the auger system.

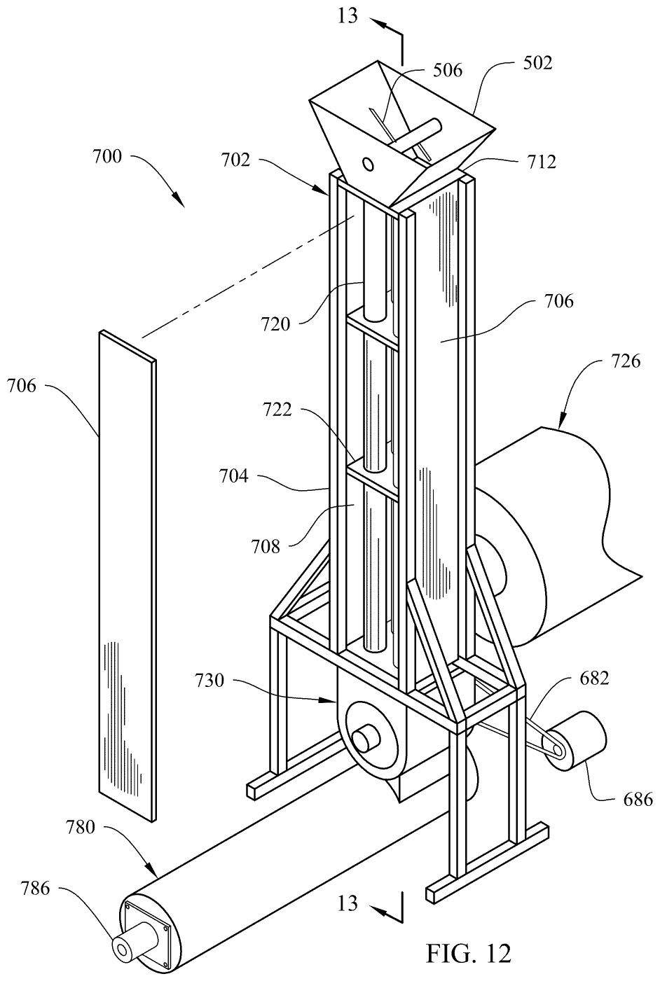

FIG. 12 is a partially exploded perspective view of a vertical heat exchanger system and a rotary feeder of the present technology.

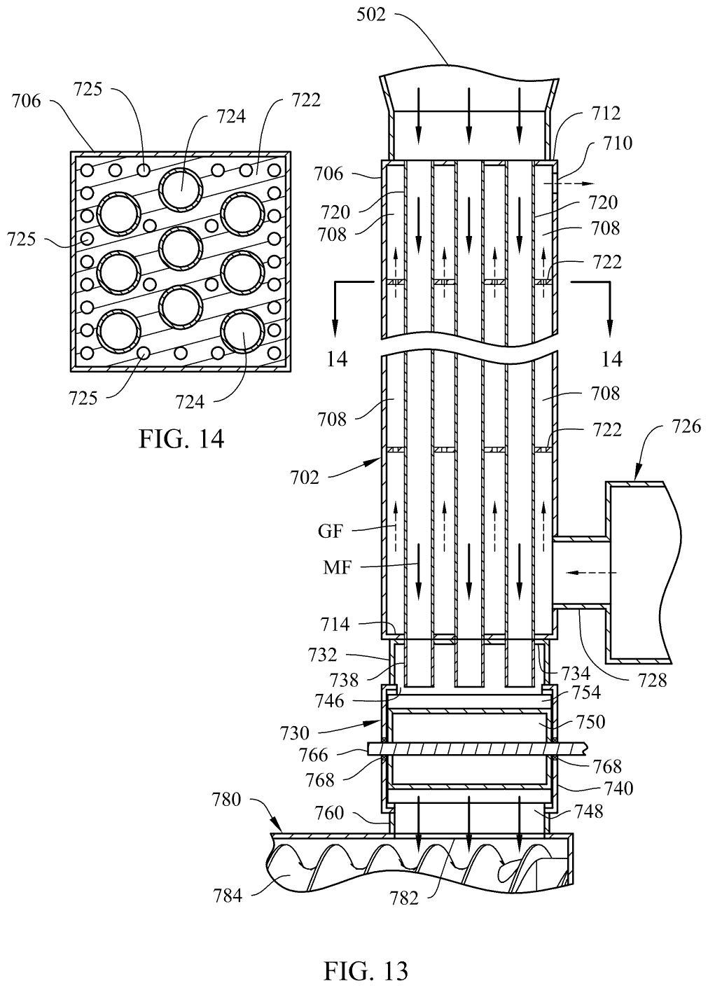

FIG. 13 is a cross-sectional view of the vertical heat exchange and the rotary feeder of FIG. 12 taken along line 13 in FIG. 12.

FIG. 14 is a cross-sectional view of a support divider of the vertical heat exchange of FIG. 12 taken along line 14 in FIG. 13.

FIG. 15 is a partially cross-sectioned perspective view of the rotary feeder of the present technology.

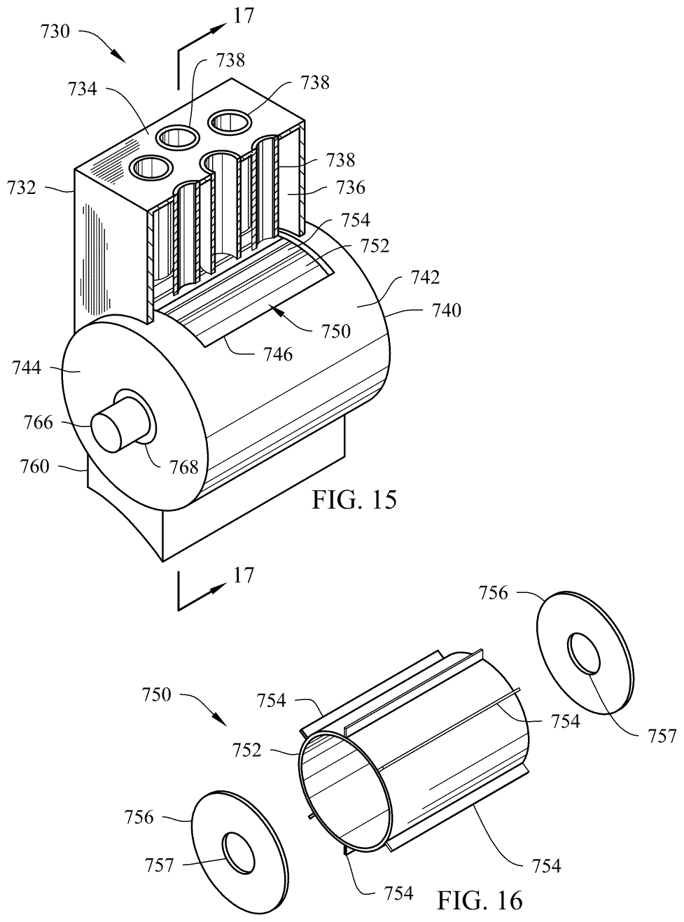

FIG. 16 is an exploded perspective view of a metering drum of the rotary feeder of the present technology.

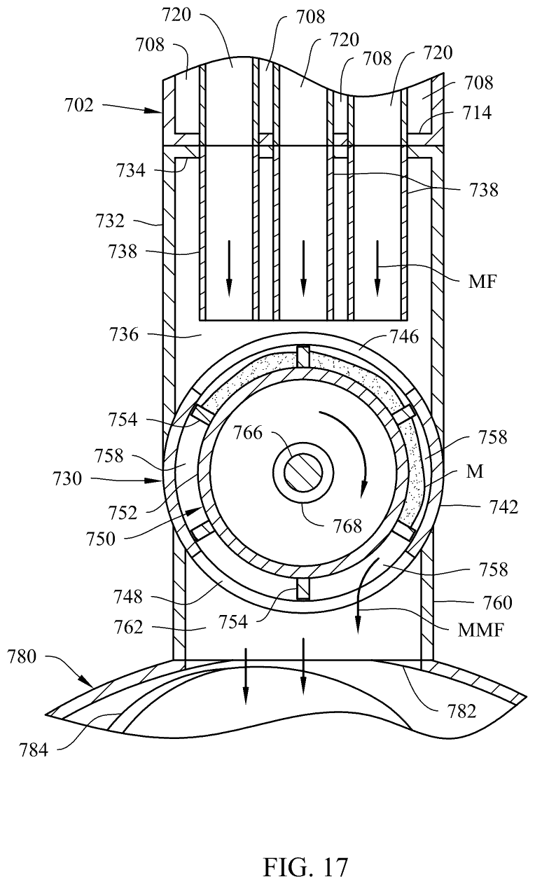

FIG. 17 is a cross-sectional view of the rotary feeder in operation taken along line 17 in FIG. 15.

The same reference numerals refer to the same parts throughout the various figures.

### DETAILED DESCRIPTION OF EMBODIMENTS OF THE PRESENT TECHNOLOGY

While the known methods and devices fulfill their respective, particular objectives and requirements, the aforementioned devices or systems do not describe mixtures and methods that allows for producing paving products from recycled asphalt shingles (RAS) and recycled asphalt pavement (RAP) particles.

A need exists for a new and novel mixtures and methods that can be used for producing paving products from recycled asphalt shingles (RAS) and recycled asphalt pavement (RAP) particles. In this regard, the present technology substantially fulfills this need. In this respect, the mixtures and methods according to the present technology substantially departs from the conventional concepts and designs of the prior art, and in doing so provides an apparatus primarily developed for the purpose of producing paving products from recycled asphalt shingles (RAS) and recycled asphalt pavement (RAP) particles.

In the following description, for purposes of explanation and not limitation, specific details are set forth, such as particular embodiments, procedures, techniques, etc. in order to provide a thorough understanding of the present technology. However, it will be apparent to one skilled in the art that the present technology may be practiced in other embodiments that depart from these specific details.

The following description sets forth various examples along with specific details to provide a thorough understanding of claimed subject matter. It will be understood by those skilled in the art, however, that claimed subject matter may be practiced without one or more of the specific details disclosed herein. Further, in some circumstances, well-known methods, procedures, systems, components and/or circuits have not been described in detail in order to avoid unnecessarily obscuring claimed subject matter. In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

Reference will now be made to FIG. 1, which provides a schematic representation of a first process used to form the composite paving block of the present technology. At the start of production line 100, there are three metered load hoppers, 101, 102 and 103. The hopper 101 being for RAS, 102 for RAP, and 103 for rock-like material that is not RAP. The RAS, RAP, and rock-like material that is not RAP are loaded into their respective hoppers with a machine such as a front-end loader or a skid steer. The RAS, RAP, and rock-like material that is not RAP are metered proportionally by mass from hoppers 101, 102, and 103 onto conveyor 114 below the hoppers. Conveyor 114 conveys the RAS, RAP, and rock-like material that is not RAP to pug mill 110. Conveyor 114 deposits the RAS, RAP, and rock-like material that is not RAP into pug mill infeed hopper 106, through which the RAS, RAP, and rock-like material that is not RAP pass to pug mill mix augers 115. Pug mill mix augers 115 blend the RAS, RAP, and rock-like material that is not RAP together into the composite material, which is then discharged through pug mill metered discharge hopper 107. There is a fourth metered load hopper 104, which is for the hard surface material. Metered load hopper 104 is loaded with a machine such as a front-end loader or a skid steer, and it discharges through chute 124 directly into preform press 140. If hard surface material is being used, then preform press mold 142 is loaded first with the hard surface material, which is metered proportionally by mass from hopper 104 onto chute 124 and from there slides into preform press mold 142; but if hard surface material is not being used then this step is skipped. The composite material is metered proportionally by mass from hopper 107 onto chute 127 and, from there, slides into preform press mold 142 of preform press 140. Preform press ram 141 applies pressure to the material in preform press mold 142 to effect compaction of the material into a preform. Preform press ram 141 is then raised to remove pressure on the preform, and preform press floor 143 is moved out of the way by the actuator to allow preform press ram 141 to press the preform down onto conveyor 117 below. Conveyor 117 conveys the preform through continuous feed oven 118, where it is heated to about 400 degrees F. (204.44° C.) and then deposits the heated preform onto chute 129. The heated preform slides down chute 129 into mold press 160. Mold press side door 161 is opened by the actuator to allow the heated preform to enter mold press mold 163. Mold press side door 161 is closed by the actuator and mold press ram 164 applies pressure to the heated preform in mold press mold 163 to effect compaction of the heated preform into a molded paving block. Mold press ram 164 is then raised to remove pressure on the molded paving block, and mold press floor 162 is moved out of the way by the actuator to allow mold press ram 164 to press the molded paving block down onto conveyor 119 below. Conveyor 119 conveys the molded paving block some distance for cooling.

Reference will now be made to FIG. 2, which provides a schematic representation of a second process used to form the composite paving block of the present technology. At the start of production line 200, there are three metered load hoppers, 101, 102, and 103. The hopper 101 is for RAS, 102 for RAP, and 103 for rock-like material that is not RAP. The RAS, RAP, and rock-like material that is not RAP are loaded into their respective hoppers with a machine such as a front-end loader or a skid steer. The RAS, RAP, and rock-like material that is not RAP are metered proportionally by mass from hoppers 101, 102, and 103 onto conveyor 114 below the hoppers. Conveyor 114 conveys the RAS, RAP, and rock-like material that is not RAP to pug mill 110. Conveyor 114 deposits the RAS, RAP, and rock-like material that is not RAP into pug mill infeed hopper 106, through which the RAS, RAP, and rock-like material that is not RAP pass to pug mill mix augers 115. Pug mill mix augers 115 blend the RAS, RAP, and rock-like material that is not RAP together into the composite material, which is then discharged through pug mill metered discharge hopper 107. The composite material is metered proportionally by mass from hopper 107 into heated auger 116 below. Heated auger 116 heats the composite material to about 400 degrees F. (204.44° C.) as it draws it toward chute 128. There is a fourth metered load hopper 105, which is for the hard surface material. Metered load hopper 105 is loaded with a machine such as a front-end loader or a skid steer. If hard surface material is being used, then mold press mold 163 is loaded first with the hard surface material, which is metered proportionally by mass from hopper 105 onto chute 125 and from there slides into mold press mold 163; but if hard surface material is not being used then this step is skipped. Heated auger 116 deposits the heated composite material onto chute 128, and the heated composite material slides down chute 128 into mold press 160. Mold press ram 164 applies pressure to the material in mold press mold 163 to effect the compaction of the material into a molded paving block. Mold press ram 164 is then raised to remove pressure on the molded paving block, and mold press floor 162 is moved out of the way by the actuator to allow mold press ram 164 to press the molded paving block down onto conveyor 119 below. Conveyor 119 conveys the molded paving block some distance for cooling.

Reference will now be made to FIG. 3, which provides a schematic representation of a third and preferred process used to form the composite paving block of the present technology. At the start of production line 300, there are four temperature-controlled metered load hoppers, 101, 102, 103, and 104, with the hopper 101 being for RAS, 102 for RAP, 103 for rock-like material that is not RAP and 104 for hard surface material. The four materials are loaded into their respective hoppers with a machine such as a front-end loader or a skid steer. The four hoppers are heated with temperature control to maintain temperatures around the following for each of the four materials: RAS 100 degrees F. (37.78° C.); RAP 140 degrees F. (60° C.); rock-like material that is not RAP 1200 degrees F. (648.89° C.); and hard surface material 450 degrees F. (232.22° C.). Press 140 is heated with temperature control to maintain its temperature around 400 degrees F. (204.44° C.). The materials are metered proportionally by mass from their hoppers via a chute into press mold 142. If hard surface material is being used, then press mold 142 is loaded first with the hard surface material, which is metered proportionally by mass from hopper 104 onto chute 124 and from there slides into press mold 142; but if hard surface material is not being used then this step is skipped. The RAS, RAP, and rock-like material that is not RAP are metered proportionally by mass from hoppers 101,102 and 103, respectively, onto chutes 121, 122, and 123, respectively, and from there slide into press mold 142 of press 140. The RAS, RAP, and rock-like material that is not RAP are loaded intermittently so that many layers of RAS are interspersed with many layers of RAP and many layers of rock-like material that is not RAP until press mold 142 is filled to the desired level. The mixture of materials with varying temperatures results in a blended temperature of around 400 degrees F. (204.44° C.). Press ram 141 applies pressure to the material in press mold 142 to effect the compaction of the material into a molded paving block. Press ram 141 is then raised to remove pressure on the molded paving block, and press floor 143 is moved out of the way by the actuator to allow press ram 141 to press the molded paving block down onto conveyor 119 below. Conveyor 119 conveys the molded paving block some distance for cooling.

Reference will now be made to FIG. 4, which provides a schematic representation of a fourth process used to form the composite paving block of the present technology. At the start of production line 400, there are four metered load hoppers, 101, 102, 103, and 104, with hopper 101 being for RAS, 102 for RAP, 103 for rock-like material that is not RAP, and 104 for hard surface material. The four materials are loaded into their respective hoppers with a machine such as a front-end loader or a skid steer. The materials are metered proportionally by mass from their hoppers via a chute into preform press mold 142. If hard surface material is being used, then preform press mold 142 is loaded first with the hard surface material, which is metered proportionally by mass from hopper 104 onto chute 124 and from there slides into preform press mold 142; but if hard surface material is not being used then this step is skipped. The RAS, RAP, and rock-like material that is not RAP are metered proportionally by mass from hoppers 101,102 and 103, respectively, onto chutes 121, 122, and 123, respectively, and from there slide into preform press mold 142 of preform press 140. The RAS, RAP, and rock-like material that is not RAP are loaded intermittently so that many layers of RAS are interspersed with many layers of RAP and many layers of rock-like material that is not RAP until the preform press mold is filled to the desired level. Preform press ram 141 applies pressure to the material in preform press mold 142 to effect compaction of the material into a preform. Preform press ram 141 is then raised to remove pressure on the preform, and preform press floor 143 is moved out of the way by the actuator to allow preform press ram 141 to press the preform down onto conveyor 117 below. Conveyor 117 conveys the preform through continuous feed oven 118, where it is heated to about 400 degrees F. (204.44° C.) and then deposits the heated preform onto chute 129. Mold press side door 161 is opened by the actuator to allow the heated preform to enter mold press mold 163. The heated preform slides down chute 129 into mold press 160. Mold press side door 161 is closed by the actuator, and mold press ram 164 applies pressure to the heated preform in mold press mold 163 to effect compaction of the heated preform into a molded paving block. Mold press ram 164 is then raised to remove pressure on the molded paving block, and mold press floor 162 is moved out of the way by the actuator to allow mold press ram 164 to press the molded paving block down onto conveyor 119 below. Conveyor 119 conveys the molded paving block some distance for cooling.

Reference will now be made to FIG. 5, which provides a schematic representation of a fifth process used to form a composite paving block 10 of the present technology. At the start of production line 500, there are three metered load hoppers, 101, 102, and 103. The hopper 101 is for RAS, 102 for RAP, and 103 for rock-like material that is not RAP. The RAS, RAP, and rock-like material that is not RAP are loaded into their respective hoppers with a machine such as a front-end loader or a skid steer. The RAS, RAP, and rock-like material that is not RAP are metered proportionally by mass from hoppers 101, 102, and 103 onto conveyor 114 below the hoppers. Conveyor 114 conveys the RAS, RAP, and rock-like material that is not RAP to a pug mill 502. Conveyor 114 deposits the RAS, RAP, and rock-like material that is not RAP into pug mill infeed hopper 504, through which the RAS, RAP, and rock-like material that is not RAP pass to pug mill mix augers or blades 506. In one or more embodiments, the conveyor 114 can be individual chutes associated with each of the hoppers 101, 102, and 103, that are configured to deposit the metered RAS, RAP, and rock-like material that is not RAP into the pug mill infeed hopper 504.

Pug mill mix augers or blades 506 blend the RAS, RAP, and rock-like material that is not RAP together into the composite material, which can then be discharged through pug mill metered discharge hopper 508. The composite material is metered proportionally by mass from hopper 508 into heated auger 116 below. Heated auger 116 heats the composite material to about 400 degrees F. (204.44° C.) as it draws it toward chute 128.

In some embodiments, the hopper 508 can be omitted and the auger 116 can receive the composite material directly or can be integrally associated with a bottom section of the pug mill 502.

The heated auger 116 deposits the heated composite material onto chute 128, while a mold press ram 516 is in a raised position, and the heated composite material slides down chute 128 into a mold press 510. Mold press ram 516 applies pressure to the material in mold press mold 512 to effect the compaction of the material into a molded paving block 10. An actuator 514 located near a bottom of the mold press mold 512 is operated to push the molded paving block 10 out from the mold press mold 512 and onto a conveyor 119. The actuator 514 can be operated while the mold press ram 516 is in the raised or lowered position. Conveyor 119 conveys the molded paving block 10 some distance for cooling.

In some embodiments, the mold press 510 can include the mold press floor 162 and actuator in place of the actuator 514 to move the mold press floor 162 out of the way to allow mold press ram 516 to press the molded paving block 10 down onto conveyor 119 below.

In one or more embodiments, there can be a fourth metered load hopper 105, which is for the hard surface material. Metered load hopper 105 is loaded with a machine such as a front-end loader or a skid steer. If hard surface material is being used, then mold press mold 512 is loaded first with the hard surface material, which is metered proportionally by mass from hopper 105 onto chute 125 and from there slides into mold press mold 512, then the material is deposited into the mold press mold 512 by chute 128 so the material is on top of the hard surface material.

Reference will now be made to FIG. 6, which provides a schematic representation of a sixth process used to form a composite paving block 10 of the present technology. At the start of production line 600, there are three metered load hoppers, 101, 102, and 103. The hopper 101 is for RAS, 102 for RAP, and 103 for rock-like material that is not RAP. The RAS, RAP, and rock-like material that is not RAP are loaded into their respective hoppers with a machine such as a front-end loader or a skid steer. The RAS, RAP, and rock-like material that is not RAP are metered proportionally by mass from hoppers 101, 102, and 103 onto conveyor 114 below the hoppers. Conveyor 114 conveys the RAS, RAP, and rock-like material that is not RAP to a pug mill 502. Conveyor 114 deposits the RAS, RAP, and rock-like material that is not RAP into pug mill infeed hopper 504, through which the RAS, RAP, and rock-like material that is not RAP pass to pug mill mix augers or blades 506. In one or more embodiments, the conveyor 114 can be individual chutes associated with each of the hoppers 101, 102, and 103, that are configured to deposit the metered RAS, RAP, and rock-like material that is not RAP into the pug mill infeed hopper 504.

Pug mill mix augers or blades 506 blend the RAS, RAP, and rock-like material that is not RAP together into the composite material, which can then be discharged through pug mill metered discharge hopper 508. The composite material is metered proportionally by mass from hopper 508 into heated auger 116 below. Heated auger 116 heats the composite material to about 400 degrees F. (204.44° C.) as it draws it toward chute 128.

The heated auger 116 transfers the heated composite material to an extruder 602 that compresses the composite material and forces it through an extruder die 604 having a paving block shape. The extruder 602 creates a continuous flow of the composite material through the extruder die 604 to form a continuous paving block 12 that exits the extruder 602 and onto to a conveyor 119. The extruder die 604 can be removable and interchangeable with other dies of different configurations, allowing different continuous paving blocks 12 to be formed.

A slicing or cutting mechanism 606 can be utilized with the extruder die 604 or the conveyor 119 to cut the continuous paving block 12 into separate paving blocks 10. Conveyor 119 conveys the cut paving blocks 10 some distance for cooling.

Referring to FIGS. 7-9, in some embodiments the heated auger 116 can include an outer cylindrical body 620 defining an outer chamber 622, and an inner cylindrical body 632 defining an inner chamber 634. The heated auger 116 can be a jacketed auger system allowing for a heated fluid to pass through the outer chamber 622, thereby heating the composite material traveling through the inner chamber 634. It can be appreciated that the inner cylindrical body 632 is concentric with the outer cylindrical body 620 along a longitudinal length of the auger 116. Further, the outer cylindrical body 620 can be capped or sealed at both its ends and with the inner cylindrical body 632 to contain the heated fluid in the outer chamber 622.

A spiral or helical baffle 624 can be located in the outer chamber 622 allow for optimal heat transfer from the heated fluid traveling through the outer chamber 622 to the inner chamber 634.

A heater 650 can be utilized to heat the fluid in a controllable manner, and to circulate the fluid to and from the outer chamber 622. It can be appreciated that the heater 650 includes any and all appropriate components to provide heat to the fluid, to receive the fluid, to output the fluid and to circulate the fluid. The heater 650 can include a computer control system, along with any required sensors and/or communication components.

The heated fluid can be, but is not limited to, an oil, water or any liquid capable of transferring heat to the inner chamber 634. In some embodiments, an oil can be used as the heated fluid as it has a delta T (ΔT) than other heating systems such as a furnace burning natural gas. The greater delta T of the furnace may overheat the composite material traveling through the auger 116, and this overheating can release volatiles which is required for binding of the composite material during the pressing process in making the paver block. Accordingly, the use the heater 650 to controllably heat the oil allows for an optimum heat transfer to the composite material traveling through the inner chamber 634, while not overheating the composite material and thereby retaining the volatiles in the composite material for assisting in the binding processes.

In some embodiments, other mechanisms to heat the inner chamber 634 can be utilized in place of or in combination with the heated fluid such as, but not limited to, recovered flue exhaust gas, a furnace, geothermal, solar, an electrical heater, electromagnetic heating, radio-frequency (RF) heating, and the like.

An input 626 can be associated with a discharge end of the outer cylindrical body 620 for providing the heated fluid from the heater 650 to the outer chamber 622. An output 628 can be associated with a receiving end of the outer cylindrical body 620 for exiting the now cooler heated fluid from the outer chamber 622 for transfer back to the heater 650.

A receiving and output section of the heater 650 that receives the cooled heated fluid from and outputs the heated fluid to the outer cylindrical body 620 can be at a height greater than a height of the input 626 and the output 628. This elevated height of the heater 650 can be utilized to control a level of the fluid, to remove any air in the fluid, and/or to prevent flooding of the heater 650.

One or more vents 630 can pass through the outer cylindrical body 620, through the outer chamber 622, and through the inner cylindrical body 632 so as to be in communication with the inner chamber 634. The vents 630 can be configured to allow steam or other gases to escape the inner chamber 634, which may have been released from the composite material heated by the heated fluid. The vents 630 can include a screen, mesh or collection system for filtering and/or capturing the escaping steam and/or gases.

An auger device 636 is rotatably received in the inner chamber 634, and in the exemplary can be operatively associated with a gear/pulley 638 that can be driven by a chain, belt or gear 684, which can be driven by a motor 686.

The pug mill 502 or any other mixing hopper can be positioned near the receiving end of the outer cylindrical body 620 to deliver the mixed composite material into the inner chamber 634 for transfer therethrough by the auger device 636.

A discharge nozzle or fitting 642 can be removably attached to the discharge end of the outer cylindrical body 620. This can be accomplished by a flange 644 that can be fastened to the discharge end. The discharge fitting 642 including a hollow interior in communication with the inner chamber 634, and configured to receive the heated composite material exiting the inner chamber 634 and the auger device 636. The discharge fitting 642 can be configured to guide the exiting heated composite material into any one of or any combination of the preform press 140, the mold press 160, the mold press 510, and the extruder 602.

The auger 116 can be supported on a base 680 by one or more support arms 682, thereby making the auger 116 transportable.

Referring to FIG. 10, in some embodiments the auger 116 can be an alternate auger 116′ having a first stage heating section and a second stage heating section. The first stage heating section can include the outer chamber 622 defining the first stage heating section, the helical baffle 624 and its corresponding input 626, output 628 and vents 630. The input 626 can be located near a discharge end of the first stage heating section, and can be configured to receive a first heated fluid at a first temperature suitable to remove moisture and/or steam from the composite material at a first stage location of the inner chamber 634 adjacent the first stage heating section. The temperature of the first heated fluid can be, but not limited to, 176 degrees F. (80° C.) to 248 degrees F. (120° C.). While the second stage heating section can receive a second heated fluid at a temperature greater than the first heated fluid to increase the temperature of the composite material to sufficient operating temperature while containing volatiles. The temperature of the second heated fluid can be, but not limited to, 248 degrees F. (120° C.) to 374 degrees F. (190° C.).

The output 628 can be associated with the receiving end of the outer cylindrical body 620 for exiting the now cooler first heated fluid from the outer chamber 622 for transfer back to the heater 650.

The second stage heating section can be between the first stage heating section and the discharge end of the outer cylindrical body 620 including the discharge fitting 642. The second stage heating section can be defined by a baffle or stop wall 653 located between the outer cylindrical body 620 and the inner cylindrical body 632, thereby sealing and separating the outer chamber 622 and a second stage outer chamber 652 of the second stage heating section.

A second stage input 656 can be associated with the discharge end of the outer cylindrical body 620 that defines the second stage outer chamber 652 for providing the second heated fluid from the heater 650 to the second stage outer chamber 652. A second stage output 658 can be associated with an end of the second stage outer chamber 652 adjacent to the stop wall 653 for exiting the now cooler second heated fluid from the second stage outer chamber 652 for transfer back to the heater 650.

A second stage helical baffle 654 can be utilized in the second stage outer chamber 652 to provide optimum heat transfer of the second heated fluid to the composite material flowing past the second stage heating section of the alternate auger 116′.

The heater 650 can be configured to separately and independently heat the first and second fluids, and to provide separate and independent circulation of the first and second fluids to and from their corresponding outer chambers 622, 652.

Referring to FIG. 11, an alternative second stage heating section is illustrated and will be described. A second heating section 662 can be associated with the discharge fitting 642 or an additional conduit connected to the discharge fitting 642. The second heating section 662 can be, but not limited to, a jacketing fluid heating assembly similar in operation to the above described auger 116. A second stage outer chamber 664 can be defined outwardly concentric with a second stage inner chamber 666 that is configured to receive the heated composite material from the auger 116. A second heated fluid is received in the second stage outer chamber 664 utilizing a second stage input 668, wherein the second heated fluid travels through the second stage outer chamber 664 to heat the received heated composite material to a temperature greater than the temperature of the heated composite material exiting the auger 116. A second stage output 670 can be associated with an end of the second stage outer chamber 664 opposite to that of the second stage input 668 for exiting the now cooler second heated fluid from the second stage outer chamber 664 for transfer back to the heater 650.

A second discharge nozzle or fitting 672 can be removably attached to the discharge end of the second heating section 660. The second discharge fitting 672 can include a hollow interior in communication with the second stage inner chamber 666, and configured to receive the heated composite material exiting the second stage inner chamber 666 and the auger device 636. The second discharge fitting 672 can be configured to guide the exiting heated composite material into any one of or any combination of the preform press 140, the mold press 160, the mold press 510, and the extruder 602.

In some embodiments, the extruder 602 and the auger 636 can be combined into a single unit. The auger 636 section can include an end section that has an auger blade compressing section that is configured to compress the heated composite material against the discharge end. The discharge fitting 642 can include or can be replaced with an extruder die. In operation, a first section of the auger 636 can be configured to transfer the composite material through the heated section of the auger 116. While a compressing section of the auger 636 can be configured to increasingly compress the heated composite material at or above 800 pounds per square inch (55.16 Bars), and in some embodiments at or above 2,000 pounds per square inch (137.90 Bars), while still transfer it toward the discharge end and thus against the extruder die. The compressed and heated composite material would then be pressed against the extruder die for shaping the composited material into a desired continuous shaped paving block, which can then be cut into preferred length blocks.

Referring to FIGS. 12-17, in some embodiments of the present technology a material processing system 700 can be utilized, or any part thereof separately, with any of the methods or processes of the present technology to produce any of the products, materials and/or construction blocks of the present technology.

As generally illustrated in FIG. 12, the material processing system 700 can include a vertical heat exchanger 702 and a material feeder 730. The vertical heat exchanger 702 can receive the mixed composite material from the pug mill or hopper 502 or any other mixing 506 or non-mixing hopper, and then allow the mixed composite material to flow/travel MF therethrough by gravity and being heated utilizing a flue gas flow GF. The now heated composite material can then enter the material feeder 730 that dispenses a metered or predetermined amount of the composite material into a material transfer device 780. In the exemplary, the material transfer device 780 can be, but not limited to an auger 784 or a conveyor, a pneumatic transfer system or any suitable means to transfer the composite material. Heated flue gas can be provided to the material processing system 700 from a flue gas source 726 directly or by way of a transfer system (not shown), where the flue gas flow GF travels up through the vertical heat exchanger 702 to heat the material flow MF traveling in an opposite direction. The transfer device 780 can be utilized to provide the now heated composite material, by way of a discharge nozzle or fitting 786, to a molding system such as, but not limited to, the preform press 140, the mold press 160, the mold press 510, the extruder 602 or any acceptable construction block forming machine. Alternatively, the metered heated composite material can be provided directly to the molding system thereby omitting the transfer device 780.

A frame 704 can be utilized as a support structure for the material processing system 700 in a substantially vertical orientation and/or the material feeder 730 and/or the transfer device 780. A heat exchanger body 706 including side panels or walls can be utilized to form an enclosed heat exchanger cavity 708 of the heat exchanger 702.

As best illustrated in FIG. 13, one or more of the side panels of the heat exchanger body 706 can include an outlet port 710 to exhaust the flue gas. An upper panel or end 712 of the material processing system 700 is configured to receive the composite material from the hopper 502 and distribute the material to one or more material conduits 720. The material conduits 720 can extend through and within the cavity 708 toward a lower panel or end 714 of the material processing system 700. The material conduits 720 can be, but not limited to, tubes, pipes, ducts, hoses and the like. The upper and lower ends 712, 714 can be sealed with or against corresponding ends of the material conduits 720 to ensure the cavity 708 is sealed from the exterior of the material processing system 700.

One or more support dividers 722 can be positioned in the cavity 708 to support the material conduits 720, as best illustrated in FIGS. 12-14. The support dividers 722 can include conduit bores 724 that receive the material conduits 720 therethrough, and plurality of gas ports 725 defined therethrough to allow the gas flow GF to pass through the support dividers 722.

In an exemplary operation as best illustrated in FIG. 13, the heated flue gas is received in the cavity 708 from the flue gas source 726 directly or by a duct 728. The gas flow GF travels upwardly in the cavity 708 around the material conduits 720 and through the ports 725 of the dividers 722, and then exits the material processing system 700 through the outlet port 710 that can be located near the upper end 712 or any location along the material processing system 700. As the gas flow GF travels through the cavity 708, the material flow MF travels downwardly by gravity through the conduits 720 from the hopper 502 toward the material feeder 730. During this counter direction of flows, the gas flow GF heats the material flow MF.

It can be appreciated that valves, baffles, flow control devices, sensors, motors, pumps, heating devices, and/or cooling devices can be utilized, integrated or incorporated with any part of the material processing system 700.

Referring to FIGS. 13 and 15, the material feeder 730 can include a material receiving section 732, a meter dispensing section 740 and a discharging section 760. The receiving section 732 can include a side walls, an upper side or end 734 that is attached to or cooperates with the lower end 714 of the heat exchanger body 706, and an opened lower end. A material receiving cavity 736 is defined in the interior of the material receiving section 732.

Multiple feeder conduits 738 can extend from the upper end 734 and are configured so as to be allignable with the conduits 720 of the material processing system 700 for receiving the heated material flow MF from the conduits 720. The feeder conduits 738 can extend into the material receiving cavity 736 a distance sufficient to provide the heater material flow MF to the meter dispensing section 740. It can be appreciated that the feeder conduits 738 can be, but not limited, tubes, pipes, ducts, hoses and the like.

The meter dispensing section 740 can include a cylindrical body 742, and a metering drum 750 rotatable in a body cavity defined in the cylindrical body 742. The cylindrical body 742 can include opposite ends 744, a receiving opening 746, and a discharge opening 748. The receiving opening 746 can be defined through an upper section of the cylindrical body 742 adjacent with and/or below free ends of the feeder conduits 738 so as to receive the material flow MF exiting the feeder conduits 738 for receipt of the metering drum 750. The discharge opening 748 can be defined through a lower section of the cylindrical body 742 opposite the receiving opening so as to discharge a metered amount of material from the metering drum 750 to the transfer device 780.

The metering drum 750, as best illustrated in FIGS. 13, 15 and 16, can include a cylindrical drum body 752, multiple paddles 754 extending outwardly from the drum body 752, and opposite end plates 756 each with a shaft bore 757. A pocket 758 is defined between radially opposing paddles 754. The shaft bore 757 of the end plates 756 is configured to receive and be secured to a shaft 766 that can be driven by a chain, belt or gear 684, which can be driven by a motor 686. The shaft 766 can pass through bearings 768 associated with the ends 744 of the cylindrical body 742 thereby providing support and rotation of the shaft 766.

In an exemplary operation and as best illustrated in FIG. 17, the heated material flow MF travels down conduits 720 and into their corresponding feeder conduits 738. The material flow MF then exits the feeder conduits 738 and passes through the receiving opening 746 of the meter dispensing section 740, where the material M is allowed to collect in the pockets 758 defined between radially opposing paddles 754.

During rotation of the shaft 766, the metering drum 750 rotates within an interior of the cylindrical body 742 thereby continuously collecting a metered amount of the material M in the pockets 758 while in communication with the receiving opening 746. The metered amount of material M can then be transferred from the receiving opening 746 to the discharge opening 748 by rotation of the metering drum 750 by way of the shaft 766.

A metered material flow MMF exits the pockets 758 by way of gravity for travel through a discharge cavity 762 defined in the discharging section 760 for subsequent receipt, in the exemplary, in an auger receiving opening 782 and transferring by an auger 784 of the transfer device 780 to a molding system. It can be appreciated that the discharging section 760 can provide the metered material flow MMF directly to the molding system thereby omitting the transfer device 780.

It can be appreciated that the metered amount of material can be adjusted by any one of or any combination of: controlling the rotational speed of the shaft 766; adjusting a diameter or width of one or more of the conduits 720 and/or the feeder conduits 738; adjusting a width and/or length of the receiving opening 746; adjusting a size of one or more of the pockets 758; adjusting a width, diameter and/or length of the cylindrical body 742; adjusting a width, diameter and/or length of the drum body 752; adjusting a width, height and/or length of one or more of the paddles 754; and adjusting a width and/or length of the discharge opening 748.

In some embodiments, the RAP material of the present technology can be or can include sand tailings, which is a byproduct from oil sands extraction process—a byproduct of separating bitumen from clay, sand and silt using high volumes of water and chemicals. Sand tailings can be a mixture of water, sand, fine silts, clay, residual bitumen and lighter hydrocarbons, inorganic salts and water-soluble organic compounds. Tailings are typically stored in basins called tailings ponds, which allow the solids in tailings to settle, or they can be recovered from ponds and piled. The present technology can first dry the sand tailings RAP to a moisture content of no more than 10%, and preferable no more than 5%. In some embodiments, already dried sand tailings can be obtained and processed into RAP with subsequent drying if required. Then the sand tailings RAP can be added to the mill or mixing hopper prior to entry into the heated auger. The use of sand tailings as RAP solves an ecological problem associated with tailing ponds and large piles of sand tailings that release hazardous chemicals into the atmosphere and/or into surrounding bodies of water. The bitumen content of the sand tailings RAP could also increase the binding properties of the composite material when pressed into the paving blocks.

With regard to all of the processes shown, although the drawings show only a single compartment in the molding systems depicted, all of the molding systems may comprise a single compartment or multiple compartments; and likewise with the support apparatus for each molding system.

With regard to certain of the processes shown, there are various ways of loading the heated preform from the continuous feed oven into the mold press, including, among others, manual loading, loading via the robotic arm, and loading via mechanically guided dropping. Mold press side door 161 and chute 129 are shown for simplicity.

With regard to certain of the processes shown, the heated preform should be appreciably shorter and thinner than mold press mold 163 so as to ease loading into mold press mold 163.

With regard to all processes shown, it is possible to preheat the RAS and RAP prior to depositing them into hoppers 101 and 102, respectively. Working with the RAS while it is below the temperature of 100 degrees F. (37.78° C.) and RAP while it is below the temperature of 140 degrees F. (60° C.) is advantageous for two reasons. The first reason is that these materials do not adhere badly to the equipment when they are below these temperatures, whereas they do adhere once they are warmed above these temperatures. Such adherence causes ongoing maintenance issues with the equipment, including the need for frequent cleaning and the need to shutdown to clear out components to avoid the risk of them requiring intensive de-gumming. The other reason is that heating RAS and RAP releases volatile organic compounds from any heated surface area. The release of these volatile organic compounds causes noxious odors that must be controlled and also reduces the binder quality of the asphalt cement in the RAS and RAP. So keeping the RAS and RAP below these threshold temperatures prior to the molding of the preform, at which point the surface area of the RAS and RAP is minimized to the surface area of the preform, is far better than heating the RAS and RAP appreciably prior to molding the preform.

With regard to certain of the processes shown, although a pug mill is shown as the blending device, there are many other adequate types of blending devices that can be used instead of a pug mill.

With regard to all processes shown, the RAS, RAP, and rock-like material that is not RAP have preferably been screened such that all pieces are of a size under 1″ in any dimension.

With regard to all processes shown, the hard surface material has preferably been screened such that all pieces are of a size under ⅜″ in any dimension.

With regard to all processes shown, it has been found that a temperature of about 250 degrees F. (121.11° C.) to about 425 degrees F. (218.33° C.), and particularly a temperature of about 350 degrees F. (176.67° C.) to about 400 degrees F. (204.44° C.), is useful in providing the proper heat for producing a molded paving block with the desired level of compressive strength and resistance to water absorption.

With regard to all processes shown, the proportional mix of RAS and RAP is important. The RAP (or rock-like material that is not RAP) provides the compressive strength and abrasion resistance of the composite material, whereas the RAS provides most of its cleavage strength and resistance to water absorption. The two together make a far superior paver than could be made with either alone. However, in an instance where the objective is to use as much RAS as possible, the proportion of RAP can be reduced. Although such RAP reduction could be taken even to the point of elimination, the loss of compressive strength becomes significant enough that the molded paving blocks produced would be unsuitable for anything other than walking paths. If the RAS component exceeds 50% then the compressive strength is essentially provided by the binder, and the aggregate is superfluous.

With regard to all processes shown, although rock-like material that is not RAP can replace RAP entirely, there is good reason to use some portion of RAP. This is because RAP is already coated with asphalt cement, whereas rock-like material that is not RAP is not coated with asphalt cement; this results in the RAS binding more easily with RAP than with rock-like material that is not RAP. When rock-like material that is not RAP is used, the asphalt cement in the RAS is absorbed to a greater degree into the rock-like material that is not RAP, thus requiring one or more of a higher percentage of RAS, higher pressure, or more dwell time in the oven.

It is contemplated that any embodiment discussed in this specification can be implemented with respect to any method of the present technology, and vice versa. It will be also understood that particular embodiments described herein are shown by way of illustration and not as limitations of the present technology. The principal features of this present technology can be employed in various embodiments without departing from the scope of the present technology. Those skilled in the art will recognize, or be able to ascertain using no more than routine experimentation, numerous equivalents to the specific procedures described herein. Such equivalents are considered to be within the scope of this present technology and are covered by the claims.

All publications and patent applications mentioned in the specification are indicative of the level of skill of those skilled in the art to which this present technology pertains. All publications and patent applications are herein incorporated by reference to the same extent as if each individual publication or patent application was specifically and individually indicated to be incorporated by reference. Incorporation by reference is limited such that no subject matter is incorporated that is contrary to the explicit disclosure herein, no claims included in the documents are incorporated by reference herein, and any definitions provided in the documents are not incorporated by reference herein unless expressly included herein.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. In embodiments of any of the compositions and methods provided herein, “comprising” may be replaced with “consisting essentially of” or “consisting of”. As used herein, the phrase “consisting essentially of” requires the specified integer(s) or steps as well as those that do not materially affect the character or function of the claimed present technology. As used herein, the term “consisting” is used to indicate the presence of the recited integer (e.g., a feature, an element, a characteristic, a property, a method/process step or a limitation) or group of integers (e.g., feature(s), element(s), characteristic(s), properties(s), method/process steps or limitation(s)) only.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

As used herein, words of approximation such as, without limitation, “about”, “substantial” or “substantially” refers to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skilled in the art recognize the modified feature as still having the required characteristics and capabilities of the unmodified feature. In general, but subject to the preceding discussion, a numerical value herein that is modified by a word of approximation such as “about” may vary from the stated value by at least ±1, 2, 3, 4, 5, 6, 7, 10, 12, 15, 20 or 25%.

All of the devices and/or methods disclosed and claimed herein can be made and executed without undue experimentation in light of the present disclosure. While the devices and methods of this present technology have been described in terms of preferred embodiments, it will be apparent to those of skill in the art that variations may be applied to the devices and/or methods and in the steps or in the sequence of steps of the method described herein without departing from the concept, spirit and scope of the present technology. All such similar substitutes and modifications apparent to those skilled in the art are deemed to be within the spirit, scope and concept of the present technology as defined by the appended claims.

What is claimed is:

1. A material processing system comprising:
a heat exchanger configured to receive a material, the heat exchanger comprising:
a heat exchanger body defining a heat exchanger cavity and having an upper end and a lower end;
one or more material conduits extending through the heat exchanger cavity from the upper end to the lower end, wherein the material conduits are configured to allow the material to flow therethrough by gravity without being in communication with the heat exchanger cavity; and
wherein the heat exchanger body is configured to receive a heated flue gas from a flue gas source and allow the heated flue gas to flow through the heat exchanger cavity to heat the material flowing in the material conduits to create a heated material.

2. The material processing system of claim 1, wherein the heat exchanger is vertically oriented and configured to allow the material to travel downwardly through the material conduits by gravity toward the lower end, and the heated flue gas to travel upwardly through the heat exchanger cavity around the material conduits toward the upper end.

3. The material processing system of claim 1, wherein the upper end of the heat exchanger is configured to receive the material from a hopper and allow the material to be received in the material conduits.

4. The material processing system of claim 1, wherein the heat exchanger further comprising one or more support dividers positioned in the heat exchanger cavity.

5. The material processing system of claim 4, wherein the support dividers include one or more conduit bores defined therethrough and one or more gas ports defined therethrough, the conduit bores being configured to receive therethrough one or more of the material conduits, and the gas ports being configured to allow the heated flue gas to flow therethrough.

6. The material processing system of claim 1 further comprising a material feeder configured to receive the heated material from the material conduits of the heat exchanger.

7. The material processing system of claim 6, wherein the material feeder includes a meter dispensing section comprising:
a cylindrical body defining a body cavity therein, a receiving opening defined through the cylindrical body, and a discharge opening defined through the cylindrical body; and
a metering drum rotatable in the cylindrical body, the metering drum comprising a cylindrical drum body, and multiple paddles extending outwardly from the drum body, wherein a pocket is defined between the paddles and are configured to receive an amount of the heated material to create a metered amount of the heated material.

8. The material processing system of claim 7, wherein the cylindrical drum body is operatively engaged with a shaft driven by a motor for rotating the shaft and thereby the cylindrical drum body.

9. The material processing system of claim 7, wherein the receiving opening being configured to receive the heated material from the material conduits, and wherein the discharge opening being configured to receive the metered amount of the heated material from the pocket and discharge the metered amount of the heated material therethrough to a material transfer device or a molding system.

10. The material processing system of claim 7, wherein the material feeder further comprising:
a receiving section including side walls defining a material receiving cavity, an upper end configured to cooperate with the lower end of the heat exchanger body, and a lower end configured to communicate with the receiving opening of the cylindrical body; and
a discharge section including side walls defining a discharge cavity in communication with the discharge opening of the cylindrical body.

11. The material processing system of claim 10, wherein the receiving section further includes one or more feeder conduits extending into the material receiving cavity towards the receiving opening of the cylindrical body, and wherein each of the feeder conduits is configured to align with one of the one or more material conduits to transfer the heated material therefrom to the receiving opening of the cylindrical body.

12. A material processing system comprising:
a material feeder configured to receive a heated material, the material feeder comprising:
a cylindrical body defining a body cavity therein, a receiving opening defined through the cylindrical body, and a discharge opening defined through the cylindrical body; and
a metering drum rotatable in the cylindrical body, the metering drum comprising a cylindrical drum body, and multiple paddles extending outwardly from the drum body, wherein a pocket is defined between each of the paddles and is configured to receive an amount of the heated material to create a metered amount of the heated material.

13. The material processing system of claim 12, wherein the cylindrical drum body is operatively engaged with a shaft driven by a motor for rotating the shaft and thereby the cylindrical drum body.

14. The material processing system of claim 12 further comprising a heat exchanger configured to heat a material to create the heated material and provide the heated material to the material feeder, and wherein the heat exchanger comprising:
a heat exchanger body defining a heat exchanger cavity and having an upper end and a lower end;
one or more material conduits extending through the heat exchanger cavity from the upper end to the lower end, wherein the material conduits are configured to allow the material to flow therethrough by gravity without being in communication with the heat exchanger cavity; and
wherein the heat exchanger body is configured to receive a heated flue gas from a flue gas source and allow the heated flue gas to flow through the heat exchanger cavity to heat the material flowing in the material conduits to create the heated material.

15. The material processing system of claim 14, wherein the heat exchanger is vertically oriented above the material feeder and configured to allow the material to travel downwardly through the material conduits by gravity toward the lower end, and the heated flue gas to travel upwardly through the heat exchanger cavity around the material conduits toward the upper end.

16. The material processing system of claim 14, wherein the receiving opening being configured to receive the heated material from the material conduits, and wherein the discharge opening being configured to receive the metered amount of the heated material from the pocket and discharge the metered amount of the heated material therethrough to a material transfer device or a molding system.

17. The material processing system of claim 14, wherein the material feeder further comprising:
a receiving section including side walls defining a material receiving cavity, an upper end configured to cooperate with the lower end of the heat exchanger body, and a lower end configured to communicate with the receiving opening of the cylindrical body; and
a discharge section including side walls defining a discharge cavity in communication with the discharge opening of the cylindrical body.

18. The material processing system of claim 17, wherein the receiving section further includes one or more feeder conduits extending into the material receiving cavity towards the receiving opening of the cylindrical body, and wherein each of the feeder conduits is configured to align with one of the one or more material conduits to transfer the heated material therefrom to the receiving opening of the cylindrical body.

19. A material processing system comprising:
a heat exchanger configured to receive a material, the heat exchanger comprising:
a heat exchanger body defining a heat exchanger cavity and having an upper end and a lower end;
one or more material conduits extending through the heat exchanger cavity from the upper end to the lower end, wherein the material conduits are configured to allow the material to flow therethrough by gravity without being in communication with the heat exchanger cavity;
wherein the heat exchanger body is configured to receive a heated flue gas from a flue gas source and allow the heated flue gas to flow through the heat exchanger cavity and heat the material flowing in the material conduits to create a heated material; and
a material feeder configured to receive the heated material from the material conduits of the heat exchanger, the material feeder including a meter dispensing section comprising:
a cylindrical body defining a body cavity therein, a receiving opening defined through the cylindrical body, and a discharge opening defined through the cylindrical body; and
a metering drum rotatable in the cylindrical body, the metering drum comprising a cylindrical drum body, and multiple paddles extending outwardly from the drum body, wherein a pocket is defined between each of the paddles and is configured to receive an amount of the heated material to create a metered amount of the heated material.

20. The material processing system of claim 19, wherein the heat exchanger is vertically oriented and configured to allow the material to travel downwardly through the material conduits by gravity toward the lower end, and the heated flue gas to travel upwardly through the heat exchanger cavity around the material conduits toward the upper end.

21. The material processing system of claim 19, wherein the upper end of the heat exchanger is configured to receive the material from a hopper and allow the material to be received in the material conduits.

22. The material processing system of claim 19, wherein the heat exchanger further comprising one or more support dividers positioned in the heat exchanger cavity.

23. The material processing system of claim 22, wherein the support dividers include one or more conduit bores defined therethrough and one or more gas ports defined therethrough, the conduit bores being configured to receive therethrough one or more of the material conduits, and the gas ports being configured to allow the heated flue gas to flow therethrough.

24. The material processing system of claim 19, wherein the cylindrical drum body is operatively engaged with a shaft driven by a motor for rotating the shaft and thereby the cylindrical drum body.

25. The material processing system of claim 19, wherein the receiving opening being configured to receive the heated material from the material conduits, and wherein the discharge opening being configured to receive the metered amount of the heated material from the pocket and discharge the metered amount of the heated material therethrough to a material transfer device or a molding system.

26. The material processing system of claim 19, wherein the material feeder further comprising:
a receiving section including side walls defining a material receiving cavity, an upper end configured to cooperate with the lower end of the heat exchanger body, and a lower end configured to communicate with the receiving opening of the cylindrical body; and
a discharge section including side walls defining a discharge cavity in communication with the discharge opening of the cylindrical body.

27. The material processing system of claim 26, wherein the receiving section further includes one or more feeder conduits extending into the material receiving cavity towards the receiving opening of the cylindrical body, and wherein each of the feeder conduits is configured to align with one of the one or more material conduits to transfer the heated material therefrom to the receiving opening of the cylindrical body.

28. A method of using the material processing system of claim 19 for making one or more construction blocks using a mixture material, the method comprising the steps of:
(a) mixing recycled asphalt shingle particles and recycled asphalt pavement particles to produce a homogenous mixture material thereof;
(b) providing the homogenous mixture material to the upper end of the heat exchanger for flowing by gravity through the material conduits toward the lower end;
(c) heating the homogenous mixture material of step (b) to a temperature from 200 degrees F. (204.44° C.) to 425 degrees F. (218.33° C.) to form the heated material by flowing the heated flue gas through the heat exchanger cavity in a counter direction to that of the flow of the homogenous mixture material through the material conduits;
(d) receiving the heated material in the receiving opening of the material feeder for collection in the pocket of the metering drum to create the metered amount of the heated material;
(e) rotating the metering drum to transfer the metered amount of the heated material in the pocket to the discharge opening; and
(f) distributing the metered amount of the heated material to a molding system to form the construction blocks.
